(19) United States
(12) Patent Application Publication
(10) Pub. No.: US 2018/0104768 A1
(43) Pub. Date: Apr. 19, 2018

(54) THE METHOD OF WIRE ANNEALING PROCESS

(71) Applicant: M.S. STEEL Klaudiusz Sobieski Sp.J., PLOCK (PL)

(72) Inventor: Klaudiusz SOBIESKI, Plock (PL)

(73) Assignee: M.S. STEEL Klaudiusz Sobieski Sp.J., PLOCK (PL)

(21) Appl. No.: 15/566,270

(22) PCT Filed: Aug. 7, 2015
(86) PCT No.: PCT/PL2015/000128

§ 371 Date: Oct. 13, 2017

(30) Foreign Application Priority Data
Apr. 14, 2015 (PL) P.411986

(51) Int. Cl. B23K 26/06; C21D 1/34; C21D 9/52

(52) U.S. Cl. CPC B23K 26/0643; C21D 9/52; C21D 1/34; B23K 26/0665

(57) ABSTRACT

The innovative wire annealing process is a constant process and includes wire heating by laser beams, and then wire reeling and cooling.

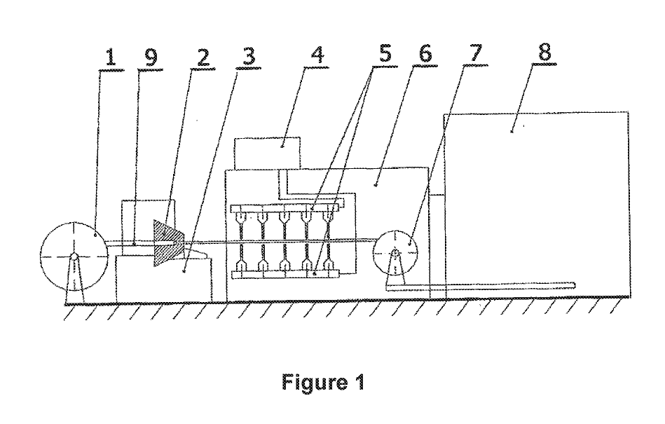

The subject of invention is a method of annealing a wire subjected to the wire drawing process.

Common wire anneal methods are based on drawing a band of metal material in multi-stage wire machines with the use of constant cooling and oiling of the drawn wire, as well as intermediate recrystallisation anneal applied in order to restore the material's ductility and avoid cracking of the drawn band.

It is obvious that the cold worked wire going out of the die, depending on the change in the sectional area on a mould, has large deformations of the material grains and so needs to be subjected to the annealing process. It is already proved that the annealed wire gains better technical parameters such as higher tensile strength, yield strength, and most of all high residual stress. In order to improve its mechanical properties, the wire is subjected to traditional furnace annealing process that lasts from 12 to 24 hours, after which time tempering is performed which concerning the energy use is a very expensive process.

The use of a laser in the annealing process of certain metal components is already known and applied, however, annealing wires with the use of lasers is the novelty.

As in a patent No. PL 112245—Steel Wire Hot Dip Galvanizing Method combined with Recrystallisation Anneal.

An application of the inventive method allows for easy regulation of the annealing temperature due to output regulation of an induction generator. High efficiency of heating can be achieved by an optimal selection of the inductor's built. The aim of the invention is an achievement of the wire homogeneous structure that would warrant its mechanical properties, high quality of zink coating with shortening the time of anneal and galvanization, lessening the size of production machinery, lowering the use of demanded energy and production costs.

As in a patent No. PL-210631 Laser Processing Apparatus.

The subject of the present invention is a laser processing apparatus improving an effective use of laser power. The invention can be applied especially for laser use in heating and cutting of various materials, preferably metals. The laser processing apparatus is composed of a head that emits laser radiation and is equipped with a concave mirror reflecting radiation reflected from the surface of a processed object. According to the present invention the surface of the concave mirror has its shape made by the linked, interpenetrating outlines of concave surfaces, preferably a sphere and ellipsoid. Such a shape of the mirror's surface improves the efficiency of the laser-processed object system.

A patent application No. KR TW201341098 defines the annealing laser processing apparatus.

The annealing laser processing apparatus consists of a bottom plate with an output interface via which goes the laser beam, the top plate set is placed on the bottom plate of the apparatus which has a transparent gap directed to the processed object.

The innovative wire annealing process is characterised by the fact that in the constant process of wire production after its drawing, the system of laser beams with power density of 0.1÷1 kW/cm² in time from 1 to 20 seconds operating on the constantly drawn wire, heats it to the temperature of about 550÷750° C., then the wire is rolled onto a reel, while the time of wire annealing on the reel under natural cooling shall not exceed 400 seconds.

The innovation of the technological process of wire production is based on introducing to the production line a system of lasers with lower energy intensity (power density of a single laser 0.1÷1 kW/cm²) for the wire pre-heating process, in comparison to the traditional furnace annealing.

A picture represents the subject of the innovation in the general arrangement.

The method of the innovative wire annealing process in the presentation consists of wire heating performed in a laser chamber (6) by a system of lasers (5) controlled by a steering master system (4) turned directly to the wire (9) just after the wire drawing in the puller (3) by the die (2). The wire (9) is constantly on the move, unreeled (1) and reeled again (9). As the experiments and researches prove, the effectiveness of laser energy use depends on laser power regulation, an amount of laser beaming density and their number from 2 to 20 in a row directed to the wire, depending on a diameter of the heated wire, so that within the period of 1 to 20 seconds a proper temperature (550÷750° C.) of the constantly shifted wire could be achieved. As a result, the thermal energy sent from the lasers to the wire renders the annealing pre-treatment process that lasts from 30 to 400 seconds, depending on the finally dedicated mechanical parameters. After the wire heating in the pre-treatment process, it shall be reeled (7), in order to be transported for the proper annealing process to the stationary furnace (8). It is assumed that thanks to the laser processing the wire will be annealed in 10÷20%. It means that at that stage the initial relaxation of residual stress (healing) and lowering of the wire mechanical properties, such as tensile strength and yield strength of 10÷20% shall be performed.

1. (canceled)

2. A wire annealing process that refers to the wire constant production process after its drawing in a puller, where a system of lasers with beams' power density of 0.1-1 kW/cm2 heats the constantly shifted wire within the period from 1 to 20 seconds to the approximate temperature of 550-750° C., which wire is then reeled, while the wire annealing time on the reel under natural cooling shall not exceed 400 seconds.
